(19) United States
(12) Patent Application Publication
(10) Pub. No.: US 2025/0222396 A1
(43) Pub. Date: Jul. 10, 2025

(54) SIMULTANEOUS H2 PRODUCTION AND CO2 CAPTURE FROM ACID GAS STREAM

(71) Applicant: Saudi Arabian Oil Company, Dhahran (SA)

(72) Inventors: Mohammad Saad AlQahtani, Dhahran (SA); John P. O'Connell, Dhahran (SA); Ahmed W. Ameen, Dhahran (SA)

(21) Appl. No.: 18/404,401

(22) Filed: Jan. 4, 2024

(51) Int. Cl. B01D 53/32; B01D 53/00; B01D 53/047; B01D 53/14; B01D 53/22; B01D 53/52; B01D 53/62; B01D 53/78; B01D 53/86; B01D 53/96; C01B 3/04; C01B 3/16; C01B 3/50; C01B 3/56; C01B 17/02; C01B 17/04; C01B 32/40

(52) U.S. Cl. CPC B01D 53/32; B01D 53/002; B01D 53/047; B01D 53/1425; B01D 53/1468; B01D 53/229; B01D 53/526; B01D 53/62; B01D 53/78; B01D 53/86; B01D 53/96; C01B 3/04; C01B 3/16; C01B 3/501; C01B 3/506; C01B 3/56; C01B 17/021; C01B 17/0404; C01B 17/0495; C01B 32/40; B01D 2252/204; B01D 2256/16; B01D 2257/304; B01D 2257/504; B01D 2259/818; C01B 2203/0277; C01B 2203/0283; C01B 2203/0405; C01B 2203/043; C01B 2203/046; C01B 2203/1205

(57) ABSTRACT

An embodiment described herein provides a method of treating a gas stream, where the method includes: flowing the gas stream containing H₂S and CO₂ into a plasma reactor; igniting a plasma in the plasma reactor containing the gas stream; decomposing the H₂S to generate H₂ and elemental sulfur in the plasma generating a product gas stream; condensing the elemental sulfur from the product gas stream as a liquid; and separating the H₂ from the product gas stream.

### TECHNICAL FIELD

This disclosure relates to methods and systems of processing, particularly to simultaneous H₂ production and CO₂ capture from acid gas stream.

### BACKGROUND

Petroleum based products, particularly oil and gas products, frequently contain significant quantities of hydrogen sulfide (H₂S) and carbon dioxide (CO₂), in addition to the desired hydrocarbons. Removal of impurities is typically required before the hydrocarbons can be further processed. Acid gases in the raw feed gas can be selectively removed, for example, by amine gas treating based on acid-base reactions.

Sulfur captured from the acid gas by such processes can be recovered as elemental sulfur in facilities such as Claus plants. Claus reaction proceeds in two steps: oxidation of H₂S to form SO₂ and H₂O, followed by formation of elemental sulfur. However, technologies currently available for H₂S decomposition are generally unable to recover hydrogen or effectively capture carbon present in the acid gases.

### SUMMARY

An embodiment described herein provides a method of treating a gas stream, where the method includes: flowing the gas stream containing H₂S and CO₂ into a plasma reactor; igniting a plasma in the plasma reactor containing the gas stream; decomposing the H₂S to generate H₂ and elemental sulfur in the plasma generating a product gas stream; condensing the elemental sulfur from the product gas stream as a liquid; and separating the H₂ from the product gas stream.

An embodiment described herein provides a method of treating a gas stream, where the method includes: performing a sorption process of an acidic feed gas using a sorbent generating a spent sorbent; performing a regeneration of the spent sorbent, where the regeneration generates a gas stream containing H₂S and CO₂; flowing the gas stream into a plasma reactor; decomposing the H₂S of the gas stream to generate H₂ and elemental sulfur in a plasma sustained in the plasma reactor generating a product gas stream, a portion of the H₂ reacting with the CO₂ to generate CO; condensing the elemental sulfur in the product gas stream as liquid; adding H₂O to the product gas stream; and performing a water-gas shift reaction in the product gas stream to generate H₂ and CO₂ consuming the CO.

An embodiment described herein provides an acid gas treatment system including: a plasma reactor to receive a gas stream at an inlet, the gas stream including H₂S and CO₂; a condenser connected to and disposed downstream of the plasma reactor; and an H₂/CO₂ separation system disposed downstream of the condenser.

### BRIEF DESCRIPTION OF DRAWINGS

FIG. 1 illustrates an example of a plasma-based system for H₂ production and CO₂ capture from acid gas, including an H₂/CO₂ separation system.

FIG. 2 illustrates an example of an H₂/CO₂ separation system with a cryogenic distillation unit.

FIG. 3 illustrates an example of an H₂/CO₂ separation system with a pressure swing adsorption (PSA) unit and a membrane separation unit.

FIG. 4 illustrates an example of an H₂/CO₂ separation system with a cryogenic distillation unit, a PSA unit, and a membrane separation unit.

FIG. 5 illustrates an example of a plasma-based system for H₂ production and CO₂ capture from acid gas, including a secondary sulfur recovery unit.

FIGS. 6A-6B illustrates example process flow diagrams of a method of H₂ production and CO₂ capture from acid gas,

FIG. 7 illustrates experimental results of a plasma-based process for H₂ production from H₂S decomposition.

### DETAILED DESCRIPTION

Embodiments described herein provide methods and systems of simultaneous hydrogen (H₂) production and carbon dioxide (CO₂) capture from acid gas stream. In various embodiments, the method includes a plasma process to decompose hydrogen sulfide (H₂S) into H₂ and elemental sulfur. In various petroleum/natural gas processes, acidic gases (e.g., H₂S and/or CO₂) present in the feed gas must be removed and separated from hydrocarbons, for example, using a scrubbing solution containing a liquid amine. The acid gases trapped in the scrubbing solution may be released during a regeneration process as a concentrated gas stream. While sulfur can be recovered from the concentrated acid gas as elemental sulfur via the Claus reaction, hydrogen is oxidized to water and CO₂ is simply diluted and uncaptured in the tail gas. Recovering hydrogen from H₂S and separating CO₂ before releasing as a tail gas can potentially improve the overall process economy and reduce the environmental footprint.

The methods and systems of plasma-based H₂ production process in various embodiments of this disclosure can enable direct decomposition of H₂S in the acid gas into elemental sulfur and generating H₂. The methods provide an alternative to the conventional Claus process. In some embodiments, the process can be integrated with various steps to improve the sulfur removal and purification of H₂ and CO₂. The methods can include a step of condensing the elemental sulfur. Further, the process may be coupled with a Claus process unit. In various embodiments, the process includes other purification steps (e.g., CO conversion by water-gas shift reaction, hydrogenation of residual sulfur, and H₂/CO₂ separation). The H₂/CO₂ separation section can be cryogenic distillation, pressure swing adsorption (PSA), membrane separation, or any combination thereof, which can be selected based on the composition of the treated gas. Selecting the appropriate H₂/CO₂ technique, the high H₂ purity of 99.9% or greater and the CO₂ purity of 99% or greater can be achieved.

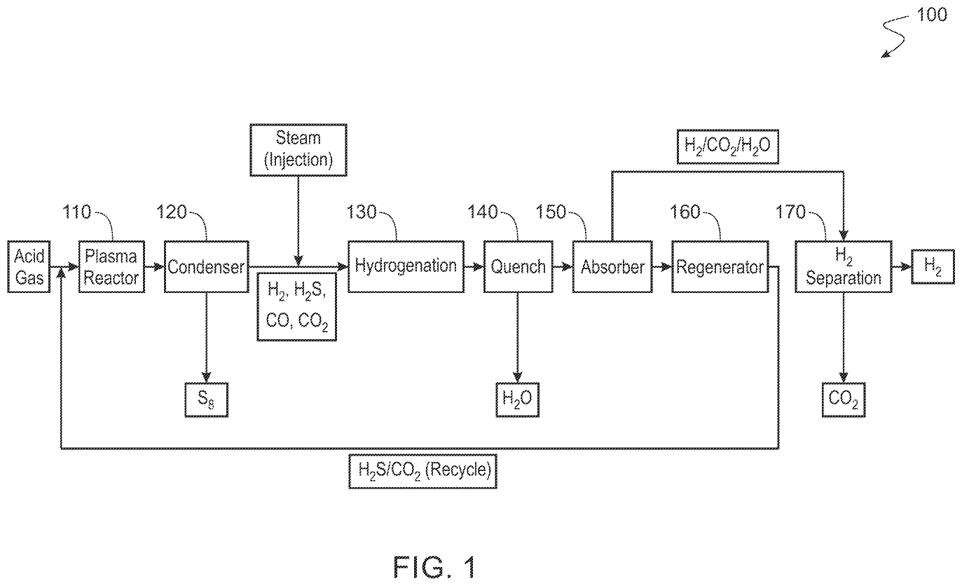

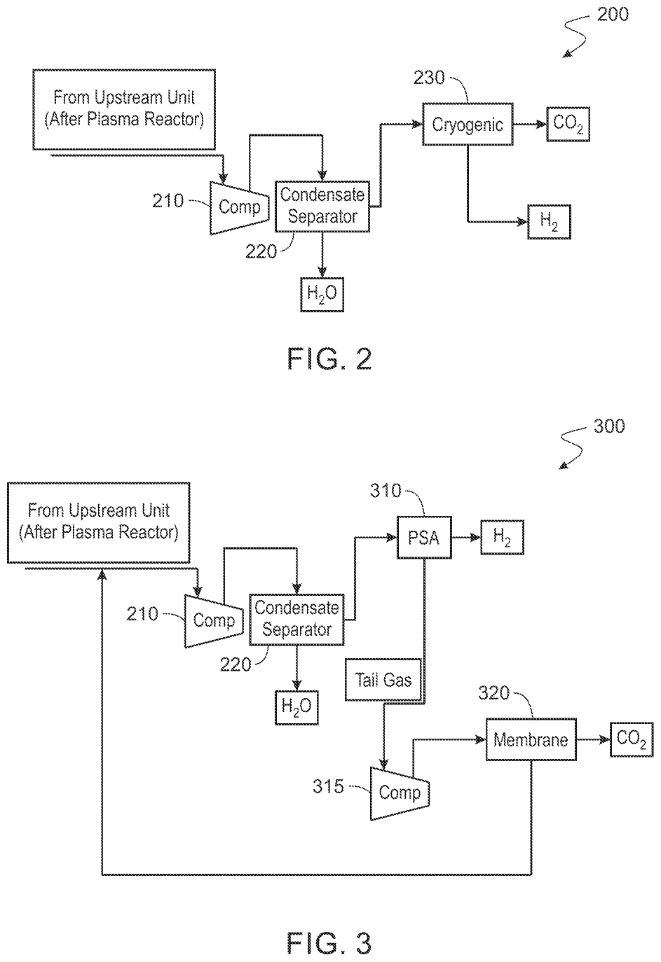

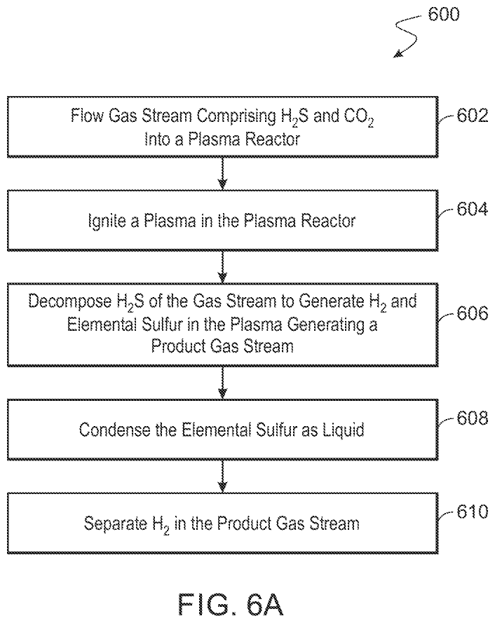

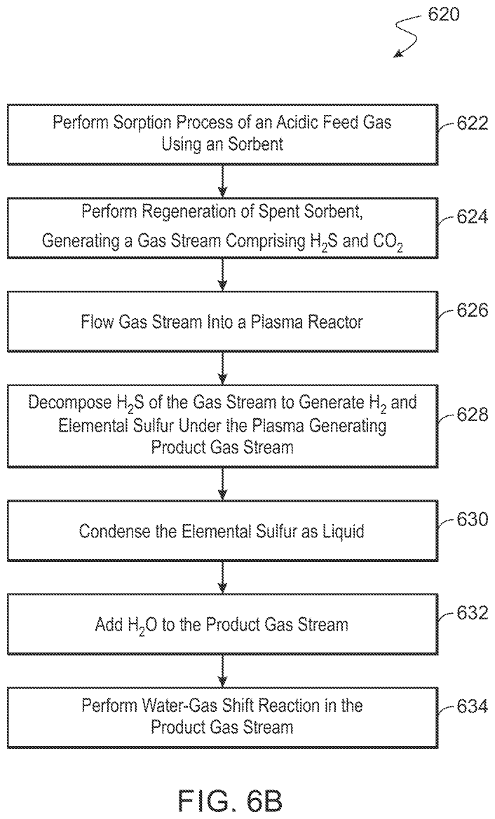

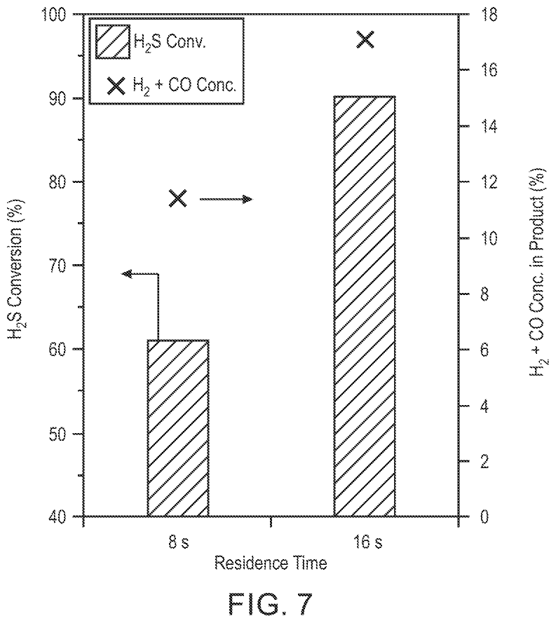

In the following, the process steps of the plasma-based H₂ production are first described referring to FIG. 1. Example schemes of H₂/CO₂ separation after the H₂ production are then described referring to FIGS. 2-4 in accordance with various embodiments. An example process integrated with a secondary sulfur recovery unit is described referring to FIG. 5. FIGS. 6A-6B illustrates example process flow diagrams. FIG. 7 and Table 1 provide H₂S conversion and H₂/CO₂ recovery obtained from experiments of the plasma-based H₂ production. In this disclosure, unless otherwise noted, concentrations of gases components in a fluid are provided based on molar concentration in percentile, referred to as %.

### Plasma-Based H₂ Production System

FIG. 1 illustrates an example of a plasma-based system for H₂ production and CO₂ capture from acid gas, including an H₂/CO₂ separation system, in accordance with some embodiments. Solid arrows are used in FIG. 1 to indicate gas flows (i.e., inflow and outflow) possible during the plasma-based process.

In FIG. 1, a plasma-based system 100 includes a plasma reactor 110, which is configured to receive an acid gas stream, for example, including H₂S or CO₂, that is to be treated by the plasma-based process. In some embodiments, the acid gas is generated and flowed from an upstream facility such as a regeneration system of an amine gas treatment facility. The method of plasma-based H₂ production can therefore include performing a sorption process of an acidic feed gas using a sorbent, and performing a regeneration of the spent sorbent, where the regeneration generates an acid gas stream comprising H₂S and CO₂. The sorption process can use a solid adsorbent, a liquid absorbent, or both. Accordingly, although not specifically illustrated in FIG. 1, the plasma reactor 110 can be connected to such an upstream facility where the acid gas is generated.

In the plasma reactor 110, a plasma can be ignited and H₂S of the acid gas stream can be decomposed to produce H₂ and elemental sulfur (referred to as reaction 1, or R1 herein). In this disclosure, the plasma means an electrically charged gas containing electrons freed from the molecules and atoms in the gas and positively charged ions. In the plasma, in addition to the H₂S decomposition, other reactions may take place such as the reverse water-gas shift reaction (referred to as reaction 2, or R2 herein) where CO₂ reacts with the produced H₂ to yield CO and H₂O.

H₂S→H₂+S (R1)

CO₂+H₂→CO+H₂O (R2)

As illustrated in FIG. 1, a first condenser 120 is disposed downstream of the plasma reactor 110 and configured to condense the elemental sulfur that is produced as liquid sulfur (e.g., S₈). The reacted sulfur is thus separated from the gas stream. The remaining gas stream can contain H₂, CO, and CO₂. In some embodiments, it also contains unreacted H₂S, depending on the plasma process conditions and the initial sulfur content in the gas stream.

In various embodiments, the remaining gas can be subsequently processed for further purification. In FIG. 1, steam is added to the gas stream before proceeding to a next step. After adding the steam, the gas stream can be introduced to a hydrogenation unit 130. In some embodiments, the hydrogenation unit includes a catalytic reactor containing one or more hydrogenation/hydrolysis catalysts to convert remaining sulfur-containing gases such as SO₂, COS, and S to H₂S (referred to as reactions 3-5, or R3-5 herein). In some embodiments, the hydrogenation/hydrolysis catalysts include supported metal or supported metal sulfide catalysts. Examples of the metal includes molybdenum, nickel, and cobalt. Further, in the hydrogenation unit, water-gas reaction (referred to as reaction 6, or R6 herein) can also be performed. In R6, CO is converted back to CO₂ generating H₂ from water. In some embodiments, water-gas shift catalysts such as supported metal oxide catalysts can also be used. In one embodiment, the water-gas shift reaction may be performed in a unit different from the hydrogenation unit. The addition of the steam prior to the hydrogenation unit can shift the equilibrium and ensure the complete conversion of CO to H₂ and CO₂.

SO₂+3H₂→H₂S+2H₂O (R3)

COS+H₂O→H₂S+CO₂ (R4)

S+H₂→H₂S (R5)

CO+H₂O→CO₂+H₂ (R6)

Still referring to FIG. 1, after the hydrogenation, the gas stream can be introduced to a quenching tower 140 to remove excess water. The gas leaving the top of the quenching tower 140 is mainly a mixture of H₂ and CO₂, and H₂S that is generated by the hydrogenation of remaining sulfur species. If the level of H₂S is sufficiently low, the gas after quenching can be directly fed to an H₂/CO₂ separation system 170.

In some embodiments, the remaining H₂S can be selectively removed by an absorption unit 150, for example, based on liquid amine absorption. As indicated by a loop in FIG. 1, this captured H₂S may be recovered by a regenerator 160 and recycled to the plasma reactor 110. Accordingly, the regenerator 160 can have an outlet connected to an inlet of the plasma reactor 110 to enable mixing of the acid gas feed with the recovered H₂S.

The H₂/CO₂ gas stream from the absorption unit 150 can be fed to the H₂/CO₂ separation system 170, where high purity H₂ and CO₂ can be recovered. In some embodiments, H₂ purity after separation is 93% or greater, for example, >97%. CO₂ purity after separation can be 90% or greater, for example, up to 99.9%.

### Plasma-Based H₂S Decomposition

In various embodiments, the plasma for H₂S decomposition can be a dielectric barrier discharge (DBD), corona discharge, pulsed corona discharge, spark, glow, gliding arc, thermal arc, or microwave plasma. Temperatures can be as low as room temperature (non-thermal plasma, NTP) or thousands of degrees (thermal plasma). Because thermal plasma is limited by a thermodynamic equilibrium, an extremely fast quenching is required for plasma process using thermal plasma to prevent recombination of sulfur and H₂.

On the other hand, NTP is a non-equilibrium process and can offer advantages in the plasma based H₂S decomposition. Although not wishing to be limited by any theory, NTP, even at relatively low temperatures, contains radicals and excited states of atoms and molecules that can exist at thermal equilibrium at much higher temperatures (>1000° C.). The non-equilibrium nature of NTP allows high H₂S conversion such as 70% or greater to take place at low temperatures such as <200° C. Accordingly, in some embodiments, a DBD plasma, an example NTP, is used. The DBD plasma can be generated applying between two electrodes, at least one of which is covered by a layer of dielectric material, a voltage higher than the breakdown voltage of the gas passing in between the two electrodes. The minimum voltage difference required to generate NTP depends on the gas composition, pressure, and the distance between the two electrodes. NTP can be operated at wide range of temperatures, for example, ranging from 30° C. to 900° C., and near atmospheric pressure such as 1-5 bar. In some embodiments, the plasma reactor 110 is maintained during the plasma-based process at a temperature between 30° C. and 800° C., for example, 150° C. and 300° C. In some embodiments, the pressure may be between 100 kPa (1 bar) and 500 kPa (5 bar), for example, 100 kPa and 300 kPa. In some embodiments, the plasma is sustained with a voltage from 1-50 kV with a frequency ranging from lower radio frequency (RF) to microwave frequencies.

In various embodiments, the plasma-based process H₂S decomposition may be performed using a catalyst to increase H₂S conversion and H₂ yield. Plasma can activate the catalyst(s) at low temperatures to increase the rate of reactions. A single catalyst, bifunctional catalyst, and/or physical mixture of different catalysts can be utilized to simultaneously catalyze different reactions such as H₂S splitting and/or water-gas shift reaction. Examples of catalysts include but are not limited to metal sulfide, supported metal sulfide, metal nitrate, supported metal nitrides, zeolite, and carbon-based catalysts. In one or more embodiments, the catalyst includes molybdenum or zinc sulfides supported on alumina.

In some embodiments, the solid catalyst is placed fully or partially in the discharge zone of the plasma reactor 110 such that the catalyst is also exposed to the plasma during the decomposition process. In alternate embodiments, the catalyst is placed downstream of the discharge zone and not directedly exposed to the plasma. In one or more embodiments, more than one catalyst is used, which can be placed both inside and outside the discharge zone.

In various embodiments, the plasma can be generated from the acid gas stream alone. In some embodiments, the plasma reactor 110 can include a gas inlet to optionally introduce a carrier or additive gas. In one or more embodiments, a noble gas such as He, Ne, Ar, Kr, and Xe, or N₂ may be introduced to the plasma reactor 110.

Although FIG. 1 illustrates only one plasma reactor, it is possible to use more than one plasma reactor or a reactor with multiple plasma chambers, where the gas stream can be treated by different plasmas in series. Further, in some embodiments, the plasma-based H₂ production process treats the gas stream with a plasma more than once with same or different plasma processing parameters, such as frequency, voltage, and residence time, among other.

### H₂/CO₂ Separation System

The plasma-treated gas stream as described above primarily contain H₂, CO₂, and H₂O. In various embodiments, each component can be separated using one or more H₂ separation techniques such as cryogenic distillation, pressure swing adsorption (PSA), and membrane separation. In some embodiments, more than one of these techniques are combined. The technology or process to recover H₂ and capture CO₂ can be selected based on the H₂ concertation in the feed of the H₂ separation unit. Because the H₂ concentration in the plasma-treated gas primarily depends on the initial H₂S concentration in the acid gas, it is possible to select the H₂ separation technique according to the initial H₂S concentration.

FIG. 2 illustrates an example of an H₂/CO₂ separation system with a cryogenic distillation unit. The use of cryogenic distillation can be advantageous when the initial H₂S concentration in the acid gas is relatively low (e.g., <20%). In such cases, the H₂ concentration in the plasma-treated gas stream can also be relatively low (e.g., 10-20%), while the CO₂ concentration can be relatively high (>80%).

An H₂/CO₂ separation system 200 is a part of the plasma-based H₂ production system as described above referring to FIG. 1 (corresponding to the H₂/CO₂ separation system 170 in FIG. 1), and thereby can be connected to an upstream facility (e.g., the absorption unit 150 in FIG. 1) and configured to receive the treated gas stream primarily including H₂, CO₂, and H₂O. In FIG. 2, the H₂/CO₂ separation system 200 includes a first compressor 210, a condensate separator 220, and a cryogenic distillation unit 230. In some embodiments, after the cryogenic distillation, the CO₂ purity is 99% or greater, and the H₂ purity is 93% or greater.

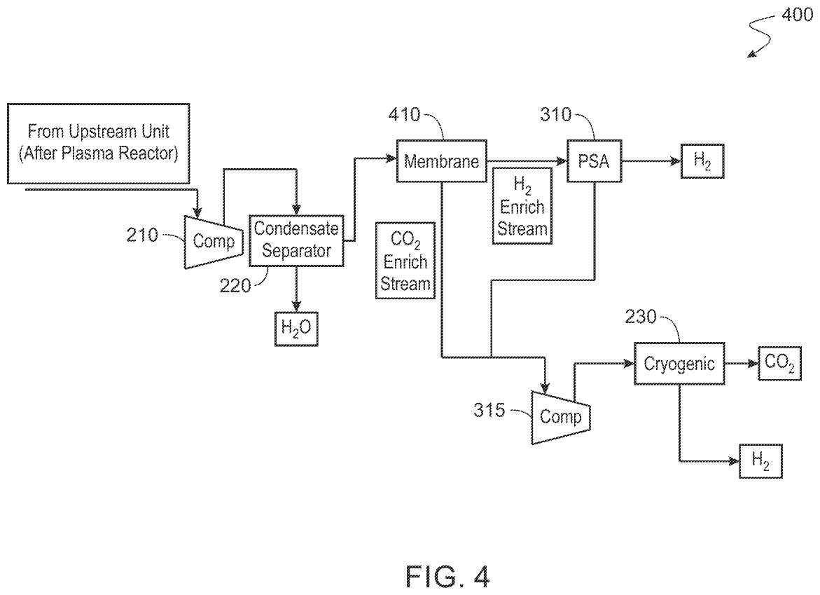

FIG. 3 illustrates an example of an H₂/CO₂ separation system with a pressure swing adsorption (PSA) unit and a membrane separation unit. The use of PSA can be advantageous when the initial H₂S concentration in the acid gas is high (e.g., >65%). In such cases, the H₂ concentration can also be relatively high (e.g., >65%).

In FIG. 3, an H₂/CO₂ separation system 300 includes a first compressor 210, a condensate separator 220, and a PSA unit 310. Further, a tail gas from the PSA unit 310 can be compressed at a second compressor 315 and sent to an H₂ selective membrane 320. At the H₂ selective membrane 320, residual H₂ is separated from the tail gas and sent back for a repeated separation cycle. In some embodiments, after the PSA-membrane combined separation, the CO₂ purity is 90% or greater, and the H₂ purity is 99.9% or greater.

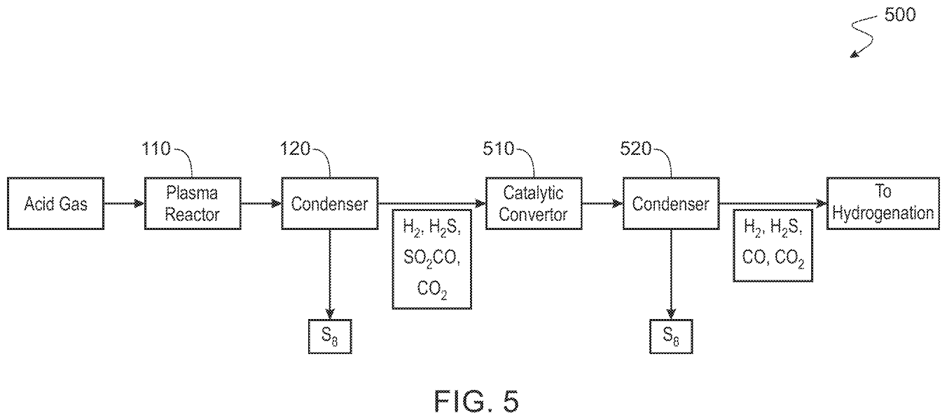

FIG. 4 illustrates an example of an H₂/CO₂ separation system with a cryogenic distillation unit, a PSA unit, and a membrane separation unit. The combined use of the three techniques can be advantageous when the initial H₂S concentration in the acid gas is moderate (e.g., 20-65%). In such cases, the H₂ concentration can also be moderate (e.g., 20-65%).

In FIG. 4, an H₂/CO₂ separation system 400 includes a first compressor 210, a condensate separator 220, and a CO₂ selective membrane 410. At the CO₂ selective membrane 410, the gas stream is separated into an H₂-enrich stream (rejected stream) and CO₂-rich stream (permeate). The H₂-enrich stream is sent to a PSA unit 310 for first H₂ recovery. The PSA tail gas and the CO₂-rich stream from the CO₂ selective membrane 410 are combined and sent to further purification. As illustrated in FIG. 4, the combined stream may be compressed by a second compressor 315 and purified using a cryogenic distillation unit 230, which separates CO₂ and residual H₂ (second H₂ recovery). In some embodiments, after the all-three combined separation, the CO₂ purity is 99% or greater, and the H₂ purity (first H₂ recovery) is 99% or greater. In alternate embodiments, liquid amine absorption can also be used in place of or in addition to the membrane separation.

### Secondary Sulfur Recovery

In various embodiments, the plasma-based H₂ production process includes multi stage units, where multiple plasma catalytic units or non-plasma catalytic units are used in series to achieve the targeted sulfur recovery level. For example, if significant amount of SO₂ is formed in the plasma reactor, then a catalytic reactor, as a means of secondary sulfur recovery, can be disposed downstream the plasma reactor to remove SO₂ via Claus reaction (referred to as reaction 7, or R7 herein). In some embodiments, alumina or titania-based catalysts are used for the Claus reaction. Because the H₂S to SO₂ ratio is expected to be much higher than the stoichiometry for Claus reaction (H₂S/SO₂>2), complete SO₂ conversion can be achieved. If only small amount of SO₂ is formed in the plasma reactor, then the catalyst can be packed in the bottom section of the plasma reactor instead of installing the catalytic reactor. In some embodiments, the catalyst is positioned outside the discharge zone such that it is not exposed to the plasma.

SO₂+2H₂S→3/xSₓ+2H₂O (R7)

FIG. 5 illustrates an example of plasma-based process for high purity H₂ production and CO₂ capture from acid gas, including a secondary sulfur recovery step, in accordance with some embodiments. In FIG. 5, a plasma-based H₂ production system 500 includes a secondary sulfur recovery step 510 coupled with a second condenser 520. Other components can be identical or similar to those of FIG. 1, and therefore some parts are omitted for illustration purpose (e.g., the hydrogenation unit 130 and any subsequent components in FIG. 1). In some embodiments, the secondary sulfur recovery step 510 is a catalytic converter to perform a Claus reaction to covert SO₂ and H₂S into elemental sulfur. The second condenser 520 can condense the produced elemental sulfur into liquid sulfur (e.g., S₈) to separate it from the treated gas stream. The treated gas stream can be sent to subsequent units for further purification as described above, such as hydrogenation, water-gas shift reaction, and H₂/CO₂ separation, among others.

In various embodiments, the concentration of initial acid gas contaminations such as hydrocarbons, BTEX (Benzene, Toluene, Xylenes), and ammonia (NH₃) are typical low (<1%). The plasma-based process can decompose some of these contaminations. For example, although not wishing to be limited by any theory, NH₃ can decompose to produce H₂ and N₂ via reaction (referred to as reaction 8, or R8 herein). Further, under a plasma condition, hydrocarbons can be cracked to lighter hydrocarbons (referred to as reactions 9-10, or R9-10 herein). The effect of these contamination on the quality of H₂ and/or CO₂ can be minimal due to their low concentration.

2NH₃→N₂+3H₂ (R8)

C₃H₈+H₂→CH₄+C₂H₆ (R9)

C₃H₈→C₂H₆+H₂+C (R10)

As described above, various embodiments enable decomposition of H₂S in acid gas and H₂ production at the same time by using a plasma-based process. The disclosed process is versatile in treating a wide range of acid gas composition, from rich H₂S acid gas to lean H₂S acid gas. This is advantageous because it can eliminate the need for acid gas enrichment unit before H₂S decomposition.

Further, the methods can withstand the presence of other contaminants in the feed, such as water vaper, N₂, hydrocarbons, and ammonia (NH₃).

### Process Flow Diagrams

FIGS. 6A-6B illustrates example process flow diagrams of a method of H₂ production and CO₂ capture from acid gas in accordance with various embodiments. In FIG. 6A, a process 600 starts with flowing a gas stream 602 including H₂S and CO₂ into a plasma reactor, followed by igniting a plasma 604 in the plasma reactor. Next, H₂S of the gas stream can be then decomposed 606 to generate H₂ and elemental sulfur in the plasma, generating a product gas stream. The elemental sulfur can be condensed 608 as liquid, followed by separating H₂ 610 in the product gas stream.

In FIG. 6B, another process 620 starts with performing adsorption process 622 of an acidic feed gas using an adsorbent, followed by performing a regeneration of the spent adsorbent 624, the regeneration generating a gas stream including H₂S and CO₂. Subsequently, the gas stream can be flowed 626 into a plasma reactor, and H₂S of the gas stream can be decomposed 628 to generate H₂ and elemental sulfur in a plasma sustained in the plasma reactor generating a product gas stream, where a portion of the produced H₂ reacting with CO₂ to generate CO and H₂O. The process 620 proceeds to condensing the elemental sulfur 630 as liquid. Next, H₂O can be added 632 to the product gas stream, followed by performing a water-gas shift reaction 634 in the product gas stream to generate H₂ and CO₂ from CO and H₂O.

### EXAMPLES

Plasma-based H₂ production from a gas stream including H₂S was experimentally demonstrated by lab scale tests. The tests were performed using a simulated acid gas containing 20% H₂S, 79.5% CO₂, and 0.5% hydrocarbons. The simulated acid gas was introduced to a plasma reactor, and a non-thermal plasma was ignited at 150° C.

FIG. 7 illustrates experimental results of a plasma-based process for H₂ production from H₂S decomposition. As illustrated in FIG. 7, in a short residence time (8-16 s), substantial H₂S conversion was achieved (60-90%) and the presence of H₂ and CO was confirmed, demonstrating the capability of a plasma process to decompose H₂S into H₂ and S.

In addition, the overall H₂ production and separation process was simulated using Aspen HYSYS. Different simulations were conducted at different H₂S content in the feed to confirm the substantially simultaneous H₂ recovery and CO₂ capture, based on the proposed process. The result is shown in Table 1.

As summarized in Table 1, by selecting the appropriate separation technique, high purity and recovery for both H₂ and CO₂ have been demonstrated in a wide range of H₂S initial concentration (15-80%). Even with the lowest H₂S initial concentration at 15%, 93% H₂ purity and >97% recovery were achieved. On the other hand, at high H₂S initial concentration (e.g., >70%), higher H₂ purity (>99.9%) was obtained, while maintaining a high CO₂ purity (>90%) and recovery (>97%).

TABLE 1
Aspen HYSYS simulation results for
plasma-based H₂ production process

| H₂S conc. | | H₂ | H₂ | CO₂ | CO₂ |
|---|---|---|---|---|---|
| in feed | | purity | recovery | purity | recovery |
| (%) | Separation method | (%) | (%) | (%) | (%) |
| 15 | Cryo | 93 | >97 | >99 | >97 |
| 20 | Cryo | 94.4 | >96 | >99 | >97 |
| 25 | MEM + PSA + Cryo | >99.9 | >58 | >99 | >97 |
| 40 | MEM + PSA + Cryo | >99.9 | >97 | >99 | >97 |
| 60 | MEM + PSA + Cryo | >99.9 | >97 | >99 | >97 |
| 70 | PSA + MEM | >99.9 | >97 | >90 | >97 |
| 80 | PSA + MEM | >99.9 | >97 | >90 | >97 |

### Embodiments

An embodiment described herein provides a method of treating a gas stream, where the method includes: flowing the gas stream containing H₂S and CO₂ into a plasma reactor; igniting a plasma in the plasma reactor containing the gas stream; decomposing the H₂S to generate H₂ and elemental sulfur in the plasma generating a product gas stream; condensing the elemental sulfur from the product gas stream as a liquid; and separating the H₂ from the product gas stream.

In an aspect, combinable with any other aspect, a portion of the H₂ reacts with the CO₂ in the plasma generating CO in the product gas stream, and the method further includes, after condensing the elemental sulfur and prior to separating the H₂, adding H₂O to the product gas stream; performing a water-gas shift reaction in the product gas stream to generate H₂ and CO₂ from the CO and the H₂O; and after the water-gas shift reaction, reducing the water content of the product gas stream.

In an aspect, combinable with any other aspect, the method further includes, after condensing the elemental sulfur, hydrogenating remaining sulfur species in the product gas stream.

In an aspect, combinable with any other aspect, the water-gas shift reaction and the hydrogenating are performed using a catalytic reactor.

In an aspect, combinable with any other aspect, the method further includes, after the hydrogenating: performing an absorption of residual H₂S in the product gas stream; performing a regeneration to generate a recovered residual H₂S stream; and mixing the recovered residual H₂S stream with the gas stream that is flowed into the plasma reactor.

In an aspect, combinable with any other aspect, reducing the water content includes feeding the product gas stream after the water-gas shift reaction to a quenching tower.

In an aspect, separating the H₂ includes performing a cryogenic distillation.

In an aspect, separating the H₂ includes performing a pressure swing adsorption (PSA).

In an aspect, separating the H₂ includes performing a membrane separation.

In an aspect, combinable with any other aspect, the plasma is a dielectric barrier discharge (DBD) plasma.

In an aspect, combinable with any other aspect, the method further includes charging the plasma reactor with a catalyst including metal sulfide, supported metal sulfide, metal nitrate, supported metal nitride, a zeolite, or a carbon-based catalyst.

In an aspect, combinable with any other aspect, SO₂ is generated from the H₂S in the plasma, and the method further includes, prior to separating the H₂, performing Claus reaction in a catalytic reactor disposed downstream of the plasma reactor, generating elemental sulfur from the SO₂.

An embodiment described herein provides a method of treating a gas stream, where the method includes: performing a sorption process of an acidic feed gas using a sorbent generating a spent sorbent; performing a regeneration of the spent sorbent, where the regeneration generates a gas stream containing H₂S and CO₂; flowing the gas stream into a plasma reactor; decomposing the H₂S of the gas stream to generate H₂ and elemental sulfur in a plasma sustained in the plasma reactor generating a product gas stream, a portion of the H₂ reacting with the CO₂ to generate CO; condensing the elemental sulfur in the product gas stream as liquid; adding H₂O to the product gas stream; and performing a water-gas shift reaction in the product gas stream to generate H₂ and CO₂ consuming the CO.

In an aspect, combinable with any other aspect, the plasma is a non-thermal plasma sustained at a temperature between 150° C. and 300° C.

In an aspect, combinable with any other aspect, the gas stream prior to the decomposing includes 10-30 vol % H₂S and 70-90 vol % CO₂.

In an aspect, combinable with any other aspect, the method further includes, after the water-gas shift reaction, separating H₂ and CO₂ in the gas stream, where the separating includes a cryogenic distillation, a pressure swing adsorption (PSA), or a membrane separation.

An embodiment described herein provides an acid gas treatment system including: a plasma reactor to receive a gas stream at an inlet, the gas stream including H₂S and CO₂; a condenser connected to and disposed downstream of the plasma reactor; and an H₂/CO₂ separation system disposed downstream of the condenser.

In an aspect, combinable with any other aspect, acid gas treatment system further includes: a hydrogenation unit connected to and disposed downstream of the condenser; a quenching tower connected to and disposed downstream of the hydrogenation unit; a liquid amine absorption unit connected to and disposed downstream of to the quenching tower; and a regenerator for liquid amine connected to the liquid amine absorption unit, the regenerator including an outlet for an acid gas, the outlet connected to the inlet of the plasma reactor.

In an aspect, combinable with any other aspect, the H₂/CO₂ separation system includes: a compressor; a condensate separator; a pressure swing adsorption (PSA) unit; and a membrane separator.

In an aspect, the PSA unit is disposed downstream of the membrane separator, and the acid gas treatment system further includes a cryogenic distillation unit disposed downstream of the PSA.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of treating a gas stream, the method comprising:
flowing the gas stream comprising H₂S and CO₂ into a plasma reactor;
igniting a plasma in the plasma reactor comprising the gas stream;
decomposing the H₂S to generate H₂ and elemental sulfur in the plasma generating a product gas stream;
condensing the elemental sulfur from the product gas stream as a liquid; and
separating the H₂ from the product gas stream.

2. The method of claim 1, wherein a portion of the H₂ reacts with the CO₂ in the plasma generating CO in the product gas stream, the method further comprising:
after condensing the elemental sulfur and prior to separating the H₂, adding H₂O to the product gas stream;
performing a water-gas shift reaction in the product gas stream to generate H₂ and CO₂ from the CO and the H₂O; and
after the water-gas shift reaction, reducing the water content of the product gas stream.

3. The method of claim 2, further comprising, after condensing the elemental sulfur, hydrogenating remaining sulfur species in the product gas stream.

4. The method of claim 3, wherein the water-gas shift reaction and the hydrogenating are performed using a catalytic reactor.

5. The method of claim 3, further comprising, after the hydrogenating:
performing an absorption of residual H₂S in the product gas stream;
performing a regeneration to generate a recovered residual H₂S stream; and
mixing the recovered residual H₂S stream with the gas stream that is flowed into the plasma reactor.

6. The method of claim 2, wherein reducing the water content comprises feeding the product gas stream after the water-gas shift reaction to a quenching tower.

7. The method of claim 1, wherein separating the H₂ comprises performing a cryogenic distillation.

8. The method of claim 1, wherein separating the H₂ comprises performing a pressure swing adsorption (PSA).

9. The method of claim 1, wherein separating the H₂ comprises performing a membrane separation.

10. The method of claim 1, wherein the plasma is a dielectric barrier discharge (DBD) plasma.

11. The method of claim 1, further comprising charging the plasma reactor with a catalyst comprising metal sulfide, supported metal sulfide, metal nitrate, supported metal nitride, a zeolite, or a carbon-based catalyst.

12. The method of claim 1, wherein SO₂ is generated from the H₂S in the plasma, the method further comprising, prior to separating the H₂, performing Claus reaction in a catalytic reactor disposed downstream of the plasma reactor, generating elemental sulfur from the SO₂.

13. A method of treating a gas stream, the method comprising:
performing a sorption process of an acidic feed gas using a sorbent generating a spent sorbent;
performing a regeneration of the spent sorbent, the regeneration generating a gas stream comprising H₂S and CO₂;
flowing the gas stream into a plasma reactor;
decomposing the H₂S of the gas stream to generate H₂ and elemental sulfur in a plasma sustained in the plasma reactor generating a product gas stream, a portion of the H₂ reacting with the CO₂ to generate CO;
condensing the elemental sulfur in the product gas stream as liquid;
adding H₂O to the product gas stream; and
performing a water-gas shift reaction in the product gas stream to generate H₂ and CO₂ consuming the CO.

14. The method of claim 13, wherein the plasma is a non-thermal plasma sustained at a temperature between 150° C. and 300° C.

15. The method of claim 13, wherein the gas stream prior to the decomposing comprises 10-30 vol % H₂S and 70-90 vol % CO₂.

16. The method of claim 13, further comprising, after the water-gas shift reaction, separating H₂ and CO₂ in the gas stream, the separating comprising a cryogenic distillation, a pressure swing adsorption (PSA), or a membrane separation.

17. An acid gas treatment system comprising:
a plasma reactor to receive a gas stream at an inlet, the gas stream comprising H₂S and CO₂;
a condenser connected to and disposed downstream of the plasma reactor; and
an H₂/CO₂ separation system disposed downstream of the condenser.

18. The acid gas treatment system of claim 17, further comprising:
a hydrogenation unit connected to and disposed downstream of the condenser;
a quenching tower connected to and disposed downstream of the hydrogenation unit;
a liquid amine absorption unit connected to and disposed downstream of to the quenching tower; and
a regenerator for liquid amine connected to the liquid amine absorption unit, the regenerator comprising an outlet for an acid gas, the outlet connected to the inlet of the plasma reactor.

19. The acid gas treatment system of claim 17, wherein the H₂/CO₂ separation system comprises:
a compressor;
a condensate separator;
a pressure swing adsorption (PSA) unit; and
a membrane separator.

20. The acid gas treatment system of claim 19, wherein the PSA unit is disposed downstream of the membrane separator, further comprising a cryogenic distillation unit disposed downstream of the PSA.
